(19) United States
(12) Patent Application Publication
(10) Pub. No.: US 2012/0328978 A1
(43) Pub. Date: Dec. 27, 2012

(54) DEVELOPING AGENT, METHOD FOR EVALUATING DEVELOPING AGENT, AND METHOD FOR PRODUCING DEVELOPING AGENT

(75) Inventor: Junichi Ishikawa, Shizuoka-ken (JP)

(73) Assignees: TOSHIBA TEC KABUSHIKI KAISHA, Tokyo (JP); KABUSHIKI KAISHA TOSHIBA, Tokyo (JP)

(21) Appl. No.: 13/526,942

(22) Filed: Jun. 19, 2012

Related U.S. Application Data
(60) Provisional application No. 61/500,321, filed on Jun. 23, 2011.

(51) Int. Cl. G03G 9/087; G01N 30/04

(52) U.S. Cl. 430/109.1; 430/137.14; 73/61.55

(57) ABSTRACT

According to one embodiment, a developing agent includes a binder resin and a coloring agent, wherein when the developing agent is subjected to methanol extraction, and a filtrate of the resulting extract is subjected to HPLC measurement, the ratio of a peak area at a retention time of 10 minutes or less to the total peak area is 15.0% or less.

### CROSS-REFERENCE TO RELATED APPLICATIONS

This application is based upon and claims the benefit of priority from U.S. Provisional Application No. 61/500,321, filed on Jun. 23, 2011, the entire contents of which are incorporated herein by reference.

### FIELD

Embodiments described herein relate generally to a developing agent which is used for developing an electrostatic image or a magnetic latent image by an electrophotographic process, an electrostatic printing process, a magnetic recording process, or the like, and a method for evaluating the same.

### BACKGROUND

Conventionally, in an electrophotographic process, an electrostatic latent image is formed on a photoconductor, the latent image is developed with a toner, the toner image is transferred onto a transfer material such as paper and then fixed thereto by means of heating or the like.

As the toner, a two-component developing agent to be used by mixing with carrier particles and a one-component developing agent to be used as a magnetic toner or a non-magnetic toner are known. These toners are produced generally by a kneading and pulverization method. The kneading and pulverization method is a method for producing desired toner particles by melt-kneading a binder resin, a pigment, a release agent such as a wax, a charge control agent, etc., cooling the resulting mixture, followed by finely pulverizing the cooled mixture, and then classifying the finely pulverized mixture. Inorganic and/or organic fine particles are added for attaching to the surfaces of toner particles produced by the kneading and pulverization method in accordance with the intended use, and thus, the toner is obtained.

When toner particles are produced by such a kneading and pulverization method, a toner having excellent properties to some extent is obtained, however, there is a restriction on the selection of toner materials. For example, in the kneading and pulverization method, a material capable of being classified after being kneaded and then economically pulverized to a desired particle diameter is required. Therefore, the kneaded material is required to be sufficiently brittle. In addition, since fine powder or coarse powder having a particle diameter outside a desired range is removed by the classification, the yield tends to decrease. Further, when a wax is incorporated in the particles, a large amount of the wax is present on the surfaces of the particles, and therefore, the chargeability, fluidity, and storage stability tend to deteriorate. In addition, it is not easy to intentionally control the shape of the toner.

In such a circumstance, recently, as a method for producing a toner capable of intentionally controlling the shape of toner particles, a method for producing a toner by a wet process such as an emulsion polymerization aggregation method or a suspension polymerization method was proposed.

For example, the emulsion polymerization aggregation method is a method in which a resin dispersion liquid is prepared by emulsion polymerization, and also a coloring agent dispersion liquid in which a coloring agent is dispersed in a solvent is separately prepared, these dispersion liquids are mixed to form aggregated particles with a size corresponding to a toner particle diameter, followed by heating to fuse the aggregated particles, whereby toner particles are obtained. According to this emulsion polymerization aggregation method, by selecting a heating temperature condition, the toner shape can be arbitrarily controlled from an indefinite to a spherical shape.

Recently, due to an increase in consciousness about environmental problems, reduction in power consumption becomes an inevitable important issue when developing products. A multifunction peripheral, which is a device for office use, uses a system in which a toner is fixed by heat and pressure, and in the multifunction peripheral, a fixing system which consumes a lot of electricity is a critical member for reducing the energy consumption of the multifunction peripheral.

An energy-saving fixing system can be realized by decreasing a temperature at which a toner is fixed to paper. However, it is necessary to adopt a resin having a low melting point for fixing a toner at a low temperature, and as a result, a problem occurs that the storage stability of the toner is deteriorated. Therefore, it is demanded to develop a toner having both low-temperature fixability and storage stability.

However, it is known that when a toner is produced using an emulsion polymerization aggregation method as described above or a suspension polymerization method, the number average molecular weight of a binder resin is decreased due to hydrolysis during the production process. The toner containing such a binder resin having a molecular weight decreased by hydrolysis does not have storage stability that the toner is essentially expected to have.

### BRIEF DESCRIPTION OF THE DRAWINGS

FIG. 1 is a graph showing the results of HPLC measurement according to an embodiment.

FIG. 2 is a graph showing the results of HPLC measurement according to an embodiment.

FIG. 3 is a graph showing the results of HPLC measurement according to an embodiment.

FIG. 4 is a graph showing the results of HPLC measurement according to an embodiment.

FIG. 5 is a graph showing the results of HPLC measurement according to an embodiment.

### DETAILED DESCRIPTION

Hereinafter, an embodiment of the invention will be described.

Further, the following embodiment is a method for producing a toner in which a fine particle dispersion obtained by dispersing fine particles in a dispersion medium such as water is subjected to aggregation to obtain particles having a particle diameter corresponding to that of a toner, however, the embodiment is not limited to this production method.

In general, according to one embodiment, the developing agent is a developing agent containing a binder resin and a coloring agent, wherein when the developing agent is subjected to methanol extraction under the following condition 1, and a filtrate of the resulting extract is subjected to high-performance liquid chromatography (HPLC) measurement under the following condition 2, the ratio of a peak area at a retention time of 10 minutes or less to the total peak area is 15.0% or less.

Condition 1 for methanol extraction

Methanol: 20 parts by weight

Toner: 2 parts by weight

Extraction temperature: 50° C.

Extraction time: 3 hours

Filter paper: ADVANTEC GC90

Condition 2 for HPLC measurement

Column: Acquity HPLC BEH C8 1.7 μm 2.1×100 mm

### Column

Column temperature: 40° C.

Mobile phase A: acetonitrile

Mobile phase B: aqueous solution of 0.1% acetic acid

Gradient condition: A/B=20/80 to 100/0 to 100/0, 0 min to 30 min to 40 min

Detector: PDA (measurement wavelength: 254 nm, wavelength resolution 1.2 nm)

Injection amount: 2 μL

Further, the method for evaluating a developing agent according to one embodiment is configured such that evaluation is performed by subjecting a developing agent containing a binder resin and a coloring agent to methanol extraction under the above condition 1, subjecting a filtrate of the resulting extract to HPLC measurement under the above condition 2, and determining as to whether or not the ratio of a peak area at a retention time of 10 minutes or less to the total peak area is 15.0% or less.

The developing agent according to the embodiment and the developing agent to be used in the method for evaluating a developing agent can be obtained by, for example, a method for producing a developing agent including: preparing a toner material dispersion liquid by mixing a particulate mixture containing a binder resin and a coloring agent with an aqueous medium; preparing a dispersion liquid containing fine particles having a particle diameter smaller than that of the particulate mixture by subjecting the toner material dispersion liquid to mechanical shearing to finely pulverize the particulate mixture; forming aggregated particles by aggregating the fine particles in the dispersion liquid containing the fine particles; obtaining fused particles by fusing the aggregated particles through heating; obtaining toner particles by filtering the fused particles; preparing a toner particle dispersion liquid by mixing the toner particles with the aqueous medium; and heating the toner particle dispersion liquid to a temperature higher than the glass transition temperature of the binder resin.

In the method for producing a developing agent, the obtaining toner particles may include washing the fused particles before filtering the fused particles, and drying the fused particles after filtering the fused particles.

Further, the method for producing a developing agent according to one embodiment includes: preparing a toner material dispersion liquid by mixing a particulate mixture containing a binder resin and a coloring agent with an aqueous medium; preparing a dispersion liquid containing fine particles having a particle diameter smaller than that of the particulate mixture by subjecting the toner material dispersion liquid to mechanical shearing to finely pulverize the particulate mixture; forming aggregated particles by aggregating the fine particles in the dispersion liquid containing the fine particles; obtaining fused particles by fusing the aggregated particles through heating; obtaining toner particles by filtering the fused particles; preparing a toner particle dispersion liquid by mixing the toner particles with the aqueous medium; subjecting the toner particle dispersion liquid to a heating treatment at a temperature higher than the glass transition temperature of the binder resin; and performing evaluation by separating the toner particles subjected to the heating treatment from the aqueous medium, subjecting the separated toner particles to methanol extraction under the above condition 1, subjecting a filtrate of the resulting extract to HPLC measurement under the above condition 2, and determining as to whether or not the ratio of a peak area at a retention time of 10 minutes or less to the total peak area is 15.0% or less.

Among the components extracted with methanol, components with a retention time of 10 minutes or less as determined by HPLC measurement are low-molecular weight components generated by the hydrolysis of the binder resin during the production process. Such low-molecular weight components deteriorate the storage stability, and therefore, the amount of such low-molecular weight components can be as low as possible. If the ratio of a peak area at a retention time of 10 minutes or less determined by HPLC measurement to the total peak area exceeds 15.0%, the storage stability is drastically deteriorated and the toner is liable to coalesce.

As the binder resin to be used in the embodiment, a polyester-based resin obtained by subjecting a dicarboxylic acid component and a diol component to an esterification reaction, followed by polycondensation can be used. Examples of the acid component include aromatic dicarboxylic acids such as terephthalic acid, phthalic acid, and isophthalic acid; and aliphatic carboxylic acids such as fumaric acid, maleic acid, succinic acid, adipic acid, sebacic acid, glutaric acid, pimelic acid, oxalic acid, malonic acid, citraconic acid, and itaconic acid. Examples of the alcohol component include aliphatic diols such as ethylene glycol, propylene glycol, 1,4-butanediol, 1,3-butanediol, 1,5-pentanediol, 1,6-hexanediol, neopentyl glycol, trimethylene glycol, trimethylolpropane, and pentaerythritol; alicyclic diols such as 1,4-cyclohexanediol and 1,4-cyclohexanedimethanol; and ethylene oxide adducts or propylene oxide adducts of bisphenol A.

Further, the above polyester component may be converted so as to have a crosslinking structure using a trivalent or higher polyvalent carboxylic acid component or a trihydric or higher polyhydric alcohol component such as 1,2,4-benzenetricarboxylic acid (trimellitic acid) or glycerin.

Two or more types of polyester resins having different compositions may be mixed and used.

Further, from the viewpoint of low-temperature fixability, the polyester resin can be an amorphous polyester resin whose glass transition temperature can be easily controlled.

The glass transition temperature of a polyester resin can be 45° C. or higher and 70° C. or lower, further can be 50° C. or higher and 65° C. or lower. If the glass transition temperature is lower than 45° C., the heat-resistant storage stability of the toner is deteriorated, and if the glass transition temperature is higher than 70° C., the low-temperature fixability of the toner is deteriorated. The weight average molecular weight Mw of the polyester resin can be 5000 or more and 50000 or less, further can be 8000 or more and 20000 or less.

The above binder resin is used as a core component, and a shell component can be provided on the surface of the core component.

As a shell resin, a styrene-acrylic resin capable of easily forming an emulsion having a small particle diameter by emulsion polymerization can be used. Among the styrene-acrylic resins, from the viewpoint of transparency, a polymethyl methacrylate resin can be used.

According to the embodiment, a release agent component can be blended in the binder resin. Examples of the release agent component include aliphatic hydrocarbon-based waxes such as low-molecular weight polyethylenes, low-molecular weight polypropylenes, polyolefin copolymers, polyolefin waxes, paraffin waxes, and Fischer-Tropsch waxes, and modified products thereof; vegetable waxes such as candelilla wax, carnauba wax, Japan wax, jojoba wax, and rice wax; animal waxes such as beeswax, lanolin, and spermaceti wax; mineral waxes such as montan wax, ozokerite, and ceresin; fatty acid amides such as linoleic acid amide, oleic acid amide, and lauric acid amide; and silicone-based waxes.

As the release agent, a release agent having an ester bond of a component composed of an alcohol component and a carboxylic acid component. Examples of the alcohol component include higher alcohols, and examples of the carboxylic acid component include saturated fatty acids having a linear alkyl group; unsaturated fatty acids such as monoenoic acid and polyenoic acid; and hydroxy fatty acids. Further examples of the carboxylic acid component include unsaturated polyvalent carboxylic acids such as maleic acid, fumaric acid, citraconic acid, and itaconic acid. Further, an anhydride thereof may also be used.

Among the above-described carboxylic acid components, unsaturated polyvalent carboxylic acid components and anhydrides thereof can be used.

As the configuration of dispersion of the release agent component in the core resin, a configuration in which the release agent is dispersed relatively much in the vicinity of the surface of the core agent can be used. This is because in an electrophotographic transfer step, in order for the release agent to exhibit the release activity in a transfer device, it is required for the release agent to moderately bleed out on the surface of the toner. Accordingly, there is an optimal value of the compatibility between the polyester resin as the core resin and the release agent component.

From the viewpoint of low-temperature fixability, the softening point of the release agent is from 60° C. to 120° C., from 70° C. to 110° C.

As the coloring agent to be used in the embodiment, a carbon black, an organic or inorganic pigment or dye, or the like is used. The coloring agent is not particularly limited, however, examples of the carbon black include acetylene black, furnace black, thermal black, channel black, and Ketjen black. Examples of the pigment or dye include fast yellow G, benzidine yellow, indofast orange, irgazin red, naphthol azo, carmen FB, permanent bordeaux FRR, pigment orange R, lithol red 2G, lake red C, rhodamine FB, rhodamine B lake, phthalocyanine blue, pigment blue, brilliant green B, phthalocyanine green, and quinacridone. These coloring agents can be used alone or in admixture.

In the embodiment, a charge control agent or the like for controlling a triboelectric charge amount can be blended. As the charge control agent, a metal-containing azo compound is used, and a complex or a complex salt in which the metal element is iron, cobalt, or chromium, or a mixture thereof can be used. Further, a metal-containing salicylic acid derivative compound is also used, and a complex or a complex salt in which the metal element is zirconium, zinc, chromium, or boron, or a mixture thereof can be used.

In the embodiment, a surfactant can be used when finely pulverizing the resin, the coloring agent, and the wax.

Examples of an anionic surfactant include sulfonate salts such as alkyl benzene sulfonate salts, alkyl naphthalene sulfonate salts, alkyl diphenyl ether disulfonate salts, and alkane sulfonate salts; fatty acid salts such as oleate salts, stearate salts, and palmitate salts; sulfate ester salts such as lauryl sulfate salts, and lauryl ether sulfate salts; and alkenyl succinate salts.

Examples of a cationic surfactant include amine salts such as lauryl amine salts, oleyl amine salts, and stearyl amine salts; and quaternary ammonium salts such as lauryl trimethyl ammonium salts, stearyl trimethyl ammonium salts, distearyl dimethyl ammonium salts, and alkyl benzyl dimethyl ammonium salts.

Examples of a nonionic surfactant include polyoxyethylene alkyl ethers such as polyoxyethylene lauryl ether, polyoxyethylene stearyl ether, and polyoxyethylene myristyl ether; polyoxyalkylene alkyl ethers such as polyoxyethylene alkylene alkyl ethers and polyoxyethylene polyoxypropylene glycol; and sorbitan fatty acid esters such as sorbitan monolaurate, sorbitan monopalmitate, and sorbitan monostearate.

In the embodiment, from the viewpoint of charging stability, an inorganic metal salt or the like cannot be used as an aggregating agent. For example, the fine particles can be aggregated by adjusting the pH of the liquid of the fine particles with an acid such as hydrochloric acid, sulfuric acid, phosphoric acid, or acetic acid. In the case of encapsulated particles, a monovalent salt such as ammonium sulfate can be used.

To the surfaces of the toner particles, an additive can be attached.

Examples of the additive include titanium oxide and silica.

Titanium oxide which can be used in the embodiment can have a crystal form of rutile, anatase, mixture of rutile and anatase, or the like. The size of the fine particles of titanium oxide is not particularly limited, however, the particle diameter or the size of the major axis thereof can be from 10 to 200 nm. The fine particles of titanium oxide are added in an amount of from 0.2 to 2.0 parts by weight, further from 0.3 to 1.5 parts by weight with respect to 100 parts by weight of toner base particles. The surfaces of the fine particles of titanium oxide can be hydrophobic in order to decrease the change in chargeability dud to the change in the external environment of the toner.

As silica which can be used in the embodiment, negatively or positively charged hydrophobized silica fine particles can be exemplified. As the negatively charged silica fine particles, those having an average particle diameter of from 4 to 120 nm, further from 5 to 70 nm are used. The negatively charged silica fine particles having a uniform particle diameter may be used alone, or the negatively charged silica fine particles having different particle diameters may be used in combination of two or more.

The negatively charged silica fine particles can be subjected to a hydrophobizing treatment. By hydrophobizing the surfaces of the negatively charged silica fine particles, the fluidity and the chargeability of the toner are further improved. The hydrophobizing treatment of the silica fine particles is performed using a silane compound such as aminosilane, hexamethyldisilazane, or dimethyldichlorosilane; or a silicone oil such as dimethyl silicone, methylphenyl silicone, a fluorine-modified silicone oil, an alkyl-modified silicone oil, an amino-modified silicone oil, or an epoxy-modified silicone oil.

Similarly, the positively charged silica fine particles can have the same particle diameter as that of the negatively charged silica, and also are subjected to a hydrophobizing treatment.

As the additive, an inorganic fine powder other than titanium oxide and silica and an organic fine powder may be added. Examples of the inorganic fine powder other than titanium oxide and silica include aluminum oxide, strontium titanate, cerium oxide, magnesium oxide, nitrides such as silicon nitride, carbides such as silicon carbide, metal salts such as calcium sulfate, barium sulfate, and calcium carbonate, fluorocarbon, and hydrotalcite. Examples of the organic fine powder include PMMA resin and charge control agents.

A kneader which can be used in the embodiment is not particularly limited as long as the kneader can melt-knead materials, and examples thereof include a single-screw extruder, a twin-screw extruder, a pressure kneader, a Banbury mixer, and a Brabender mixer. Specific examples thereof include FCM (manufactured by Kobe Steel, Ltd.), NCM (manufactured by Kobe Steel, Ltd.), LCM (manufactured by Kobe Steel, Ltd.), ACM (manufactured by Kobe Steel, Ltd.), KTX (manufactured by Kobe Steel, Ltd.), GT (manufactured by Ikegai, Ltd.), PCM (manufactured by Ikegai, Ltd.), TEX (manufactured by the Japan Steel Works, Ltd.), TEM (manufactured by Toshiba Machine Co., Ltd.), ZSK (manufactured by Warner K.K.), and KNEADEX (manufactured by Mitsui Mining Co., Ltd.).

Examples of a mechanical shearing device which can be used in the embodiment include medialess stirrers such as Ultra Turrax (manufactured by IKA Japan K.K.), T.K. Auto Homo Mixer (manufactured by Primix Corporation), T.K. Pipeline Homo Mixer (manufactured by Primix Corporation), T.K. Filmix (manufactured by Primix Corporation), Clearmix (manufactured by M-Technique Co., Ltd.), Clear SS5 (manufactured by M-Technique Co., Ltd.), Cavitron (manufactured by Eurotec, Ltd.), and Fine Flow Mill (manufactured by Pacific Machinery & Engineering Co., Ltd.); and media stirrers such as Visco mill (manufactured by Aimex Co., Ltd.), Apex mill (manufactured by Kotobuki Industries Co., Ltd.), Star Mill (manufactured by Ashizawa Finetech, Ltd.), DCP Super flow (manufactured by Nippon Eirich Co., Ltd.), MP Mill (manufactured by Inoue Manufacturing Co., Ltd.), Spike Mill (manufactured by Inoue Manufacturing Co., Ltd.), Mighty Mill (manufactured by Inoue Manufacturing Co., Ltd.), and SC Mill (manufactured by Mitsui Mining Co., Ltd.).

In the embodiment, an apparatus for producing resin fine particles by mechanical shearing is not particularly limited, however, examples thereof include medialess stirrers such as Ultra Turrax (manufactured by IKA Japan K.K.), T.K. Auto Homo Mixer (manufactured by Primix Corporation), T.K. Pipeline Homo Mixer (manufactured by Primix Corporation), T.K. Filmix (manufactured by Primix Corporation), Clearmix (manufactured by M-Technique Co., Ltd.), Clear SS5 (manufactured by M-Technique Co., Ltd.), Cavitron (manufactured by Eurotec, Ltd.), and Fine Flow Mill (manufactured by Pacific Machinery & Engineering Co., Ltd.); and high-pressure homogenizer-type apparatuses such as Manton Gaulin high-pressure homogenizer (manufactured by Niro Soavi, Inc.), Microfluidizer (manufactured by Mizuho Industrial Co., Ltd.), Nanomizer (manufactured by Nanomizer, Inc.), Altimizer (manufactured by Sugino Machine, Ltd.), Genus PY (manufactured by Hakusui Chemical Industries Co., Ltd.), and NANO 3000 (manufactured by Beryu Co., Ltd.).

Examples of a mixer for mixing the fine particles with the toner particles include Henschel Mixer (manufactured by Mitsui Mining Co., Ltd.), Super Mixer (manufactured by Kawata MFG Co., Ltd.), Ribocorn (manufactured by Okawara Corporation), Nauta Mixer (manufactured by Hosokawa Micron Corporation), Turbulizer (manufactured by Hosokawa Micron Corporation), Cyclomix Mixer (manufactured by Hosokawa Micron Corporation), Spiralpin Mixer (manufactured by Pacific Machinery & Engineering Co., Ltd.), and Lodige Mixer (manufactured by Matsubo Corporation).

In the embodiment, further, coarse particles and the like may be sieved off. Examples of a sieving device which is used for sieving include Ultra Sonic (manufactured by Koei Sangyo Co., Ltd.), Gyro Sifter (manufactured by Tokuju Corporation), Vibrasonic System (manufactured by Dalton Co., Ltd.), Soniclean (manufactured by Shinto Kogyo K.K.), Turbo Screener (manufactured by Turbo Kogyo Co., Ltd.), Micro Sifter (manufactured by Makino Mfg. Co., Ltd.), and a circular vibrating sieve.

### EXAMPLES

Hereinafter, the embodiments of this disclosure will be specifically described by showing Examples.

### Method for Heating Treatment of Toner

### Redispersion of Toner

In 30 parts by weight of a toner, ion exchanged water in an amount 8 to 50 times the amount of the toner, and a surfactant in an amount of 5 wt % of the amount of the toner were mixed, whereby a dispersion liquid was obtained.

### Heating of Toner

While stirring the above toner dispersion liquid, an aqueous solution of 0.1 wt % KOH was added dropwise thereto to adjust the pH thereof. Then, the temperature of the dispersion liquid was raised to the glass transition temperature of the toner or higher, and heating was performed for 1 hour.

### Washing, Drying, and Treatment of Attachment of Additive to Surfaces of Toner Particles

Washing and filtration were repeated with an arbitrary method such as a filter paper or a filter press, whereby a hydrous cake was obtained. The hydrous cake was dried until the water content was decreased to about 1 wt % with an arbitrary drying method such as a flush dryer, a vibration dryer, or an oven. The dried material was pulverized with an arbitrary method. The resulting dried particles were used as toner particles.

The surfaces of the toner particles were subjected to a treatment of attaching silica, titanium oxide, or the like thereto, whereby a toner was obtained.

### Method for HPLC Measurement

### Methanol Extraction

2 Parts by weight of the toner was mixed with 20 parts by weight of methanol, and the resulting mixture was heated to 50° C. for 3 hours. Then, a supernatant was filtered. As a filter paper, ADVANTEC GC90 was used.

### HPLC Measurement

In liquid chromatography, Acquity HPLC system manufactured by Waters Co., Ltd. was used, and a filtrate obtained by filtering the supernatant was subjected to the measurement under the following condition.

Column: Acquity HPLC BEH C8 1.7 μm 2.1×100 mm Column

Column temperature: 40° C.

Mobile phase A: acetonitrile

Mobile phase B: aqueous solution of 0.1% acetic acid

Gradient condition: A/B=20/80 to 100/0 to 100/0, 0 min to 30 min to 40 min

Detector: PDA (measurement wavelength: 254 nm, wavelength resolution 1.2 nm)

Injection amount: 2 μL

### Measurement of Circularity

To 0.05 g of the toner particles, 30 mL of pure water and 2 mL of an anionic soap were added, and the resulting mixture was dispersed by an ultrasonic disperser for 5 minutes. Then, the resulting dispersion was measured by FPIA-2100 manufactured by Sysmex Corporation, and an average circularity was determined. As for the circularity, from the viewpoint of prevention of coalescence of toner particles, the average circularity can be 0.95 or more and 0.98 or less.

### Measurement of Particle Diameter

A particle diameter was measured using a Coulter particle size analyzer (manufactured by Beckman Coulter, Inc.). An aperture diameter used was 100 μm. As for the particle diameter, from the viewpoint of prevention of coalescence of toner particles, the volume average particle diameter can be 4.5 μm or more and 6.5 μm or less, and the CV value of the volume average particle diameter can be 30% or less.

### Measurement of Storage Stability

The storage stability was measured using a powder tester (model PT-D, Hosokawa Micron Corporation) and evaluated. 20 g of the toner obtained by attaching the additive to the toner particles was weighed and left in an environment at 50° C. for 8 hours. Thereafter, the toner was put in a sieve from above. The sieve had an opening of 150 μm and was laid on a vibration table in an overlapping manner. After the toner was put in the sieve, the sieve was vibrated for 10 seconds, and the weight of the toner remaining on the sieve was measured.

Evaluation can be performed as follows: the case where the weight of the toner remaining on the sieve exceeds 1.0 g does not satisfy the storage stability, and the case where the weight of the toner remaining on the sieve is 1.0 g or less satisfies the storage stability.

### Example 1

90 Parts by weight of a polyester resin (Tg: 61° C.) as a binder resin, 5 parts by weight of a cyan pigment (copper phthalocyanine) as a coloring agent, 4 parts by weight of an ester wax, and 1 part by weight of a zirconia metal complex as a charge control agent were mixed, and the resulting mixture was melt-kneaded using a twin-screw kneader which was set to a temperature of 120° C., whereby a kneaded material was obtained.

The thus obtained kneaded material was coarsely pulverized to a volume average particle diameter of 1.2 mm using a hammer mill manufactured by Nara Machinery Co., Ltd., whereby coarse particles were obtained.

Then, the obtained coarse particles were put into a bantam mill manufactured by Hosokawa Micron Corporation which was set to a rotational speed of 12000 rpm, whereby moderately pulverized particles were obtained. The volume average particle diameter of the moderately pulverized particles was measured using SALD-7000 (manufactured by Shimadzu Corporation) and found to be 59.3 μm.

40 Parts by weight of the moderately pulverized particles, 2 parts by weight of sodium dodecylbenzene sulfonate as a dispersing agent, 2 parts by weight of a sodium salt of a copolymer of acrylic acid and maleic acid, 2 parts by weight of triethylamine as a dispersing aid, and 55 parts by weight of ion exchanged water were preliminarily dispersed using ULTRA TURRAX T50 manufactured by IKA Japan K.K., whereby a preliminary dispersion liquid was obtained.

The thus obtained preliminary dispersion liquid was put into a Nanomizer (manufactured by Yoshida Kikai Co. Ltd., YSNM-2000AR additionally having a heating system). The temperature of the heating system was set to 160° C., and the dispersion liquid was processed at a processing pressure of 160 MPa in the Nanomizer. The processing was repeated three times. The volume average particle diameter of the colored particles obtained after cooling was measured using SALD-7000 (manufactured by Shimadzu Corporation) and found to be 0.42 μm. While maintaining the dispersion liquid at 40° C., 2 parts by weight of aluminum sulfate was added thereto, and the temperature of the mixture was raised to 55° C. to aggregate the colored fine particles to a desired volume average particle diameter, whereby an aggregated particle dispersion liquid was obtained. Thereafter, the temperature of the mixture was raised to 90° C. and the mixture was left as such for 3 hours, whereby a fused particle dispersion liquid was obtained.

Subsequently, the thus obtained fused particle dispersion liquid was subjected to washing by repeating filtration and washing with ion exchanged water until the electrical conductivity of the filtrate was lowered to 50 μS/cm. Then, drying was performed using a vacuum dryer until the water content was lowered to 1.0% by weight or less, whereby toner particles A were obtained.

The physical properties of the thus obtained toner particles were measured by the above-described methods, and it was found that the particle diameter was 4.8 the circularity was 0.963, the glass transition temperature was 53.5° C., and the storage stability at 60° C. was 20.0 g, which was favorable.

When substances present in the vicinity of the surfaces of the toner particles A were measured by high-performance liquid chromatography (HPLC), the ratio of a peak area at a retention time of 10 minutes or less to the total peak area was 11.3%.

The toner particles A were redispersed by the above-described method, whereby a toner particle dispersion liquid having a solid content of 10% was obtained. While stirring the dispersion liquid, an aqueous solution of 0.1 wt % KOH was added dropwise thereto to adjust the pH thereof to 10.2. Then, the temperature of the dispersion liquid was raised to 80° C., and heating was performed for 1 hour. After being cooled naturally, the resulting dispersion liquid was filtered, and the residue was washed and dried, whereby the toner particles A subjected to the heating treatment were obtained. The thus obtained toner particles A had a particle diameter of 5.2 μm, a circularity of 0.966, and a storage stability at 60° C. of 0.1 g.

The toner particles A subjected to the heating treatment were dispersed in methanol, and components present in the vicinity of the surface were extracted at 50° C. for 3 hours, and the extracted components were subjected to HPLC measurement. As a result, the ratio of a peak area at a retention time of 10 minutes or less to the total peak area was 6.7%. In addition, the ratio of a peak area at a retention time of 10 minutes or less to the total peak area before the heating treatment was 11.3%. Further, the ratio of the peak area before and after the heating treatment was 59.8%.

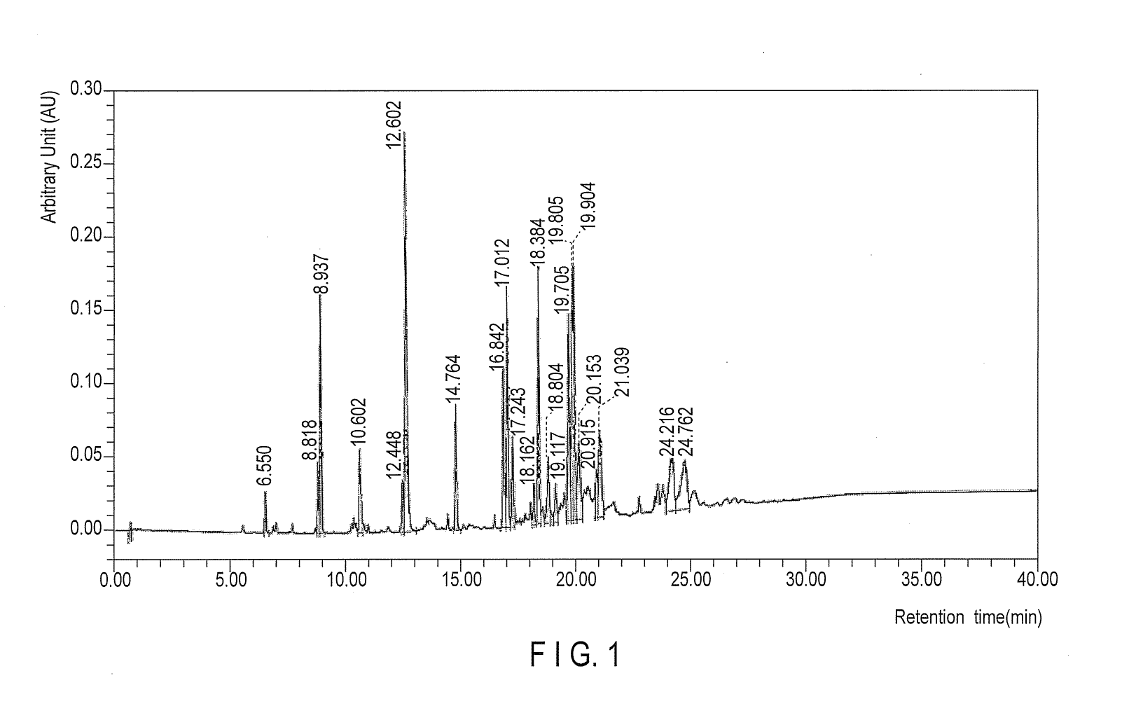

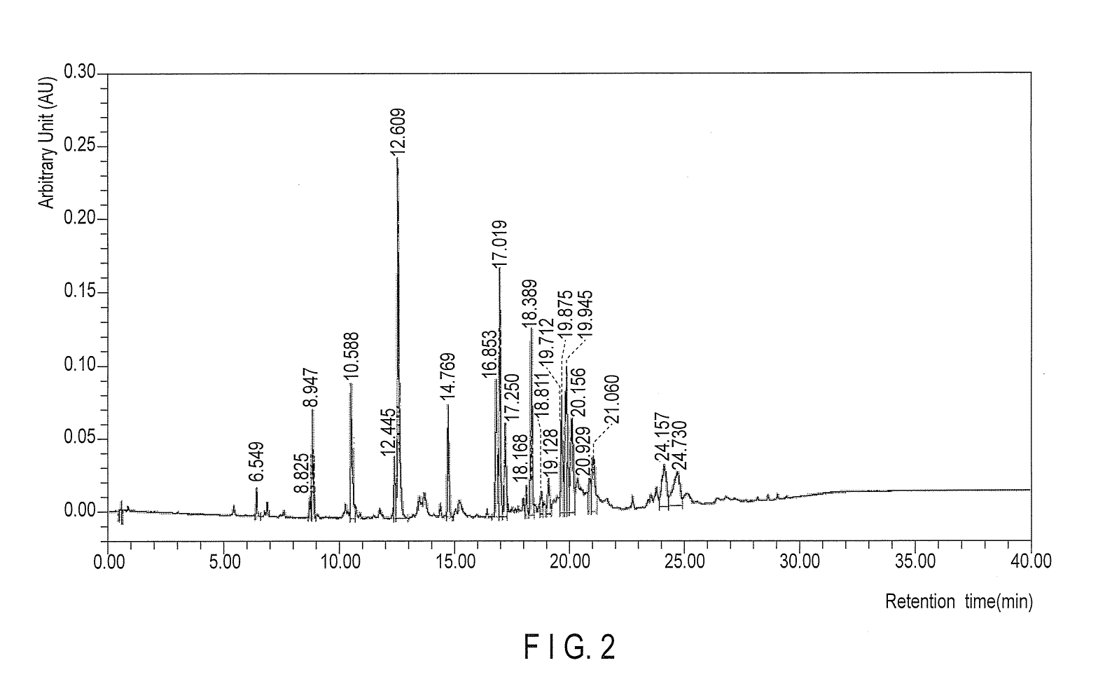

The graph showing the results of HPLC measurement of the toner particles A before the heating treatment is shown in FIG. 1 and after the heating treatment is shown in FIG. 2.

In graphs a value of the vertical axis shows a relative value of a measured value for a measured material to a measured value for a standard material.

Further, the results of the peak area determined by the HPLC measurement of the toner particles A are shown in the following Table 1. In addition, the results of the percentage of the area determined by the HPLC measurement are shown in the following Table 2. Further, the results of the respective measurements are shown in Table 3.

### Example 2

90 Parts by weight of a polyester resin (Tg: 61° C.) as a binder resin, 5 parts by weight of a cyan pigment (copper phthalocyanine) as a coloring agent, 4 parts by weight of an ester wax, and 1 part by weight of a zirconia metal complex as a charge control agent were mixed, and the resulting mixture was melt-kneaded using a twin-screw kneader which was set to a temperature of 120° C., whereby a kneaded material was obtained.

The thus obtained kneaded material was coarsely pulverized using a feather mill and then pulverized using a jet mill. Then, the pulverized material was classified using a rotor classifier, whereby toner particles C were obtained.

The physical properties of the thus obtained toner particles were measured by the above-described methods, and it was found that the particle diameter was 4.8 μm, the circularity was 0.950, the glass transition temperature was 54.5° C., and the storage stability at 47° C. was 0.1 g, which was favorable.

When substances present in the vicinity of the surfaces of the toner particles C were measured by HPLC, the ratio of a peak area at a retention time of 10 minutes or less to the total peak area was 9.9%.

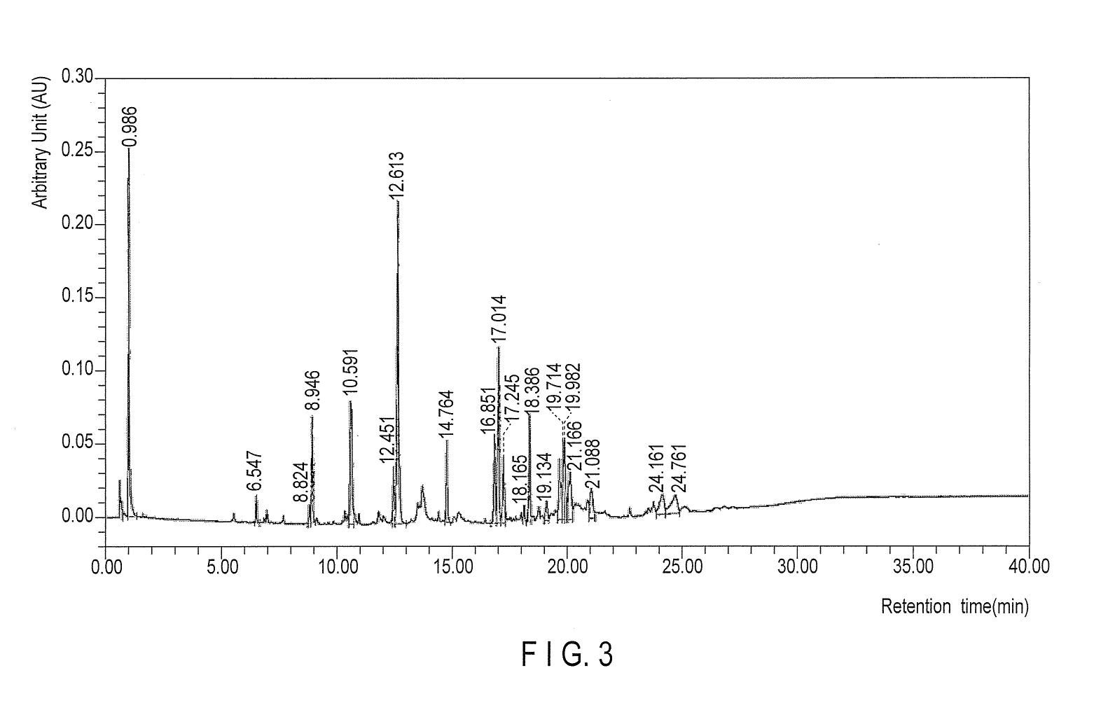

The graph showing the results of HPLC measurement of the toner particles C is shown in FIG. 3.

Further, the results of the peak area determined by the HPLC measurement of the toner particles C are shown in the following Table 1. In addition, the results of the percentage of the area determined by the HPLC measurement are shown in the following Table 2. Further, the results of the respective measurements are shown in Table 3.

### Comparative Example 1

90 Parts by weight of a polyester resin (Tg: 61° C.) as a binder resin, 5 parts by weight of a cyan pigment (copper phthalocyanine) as a coloring agent, 4 parts by weight of an ester wax, and 1 part by weight of a zirconia metal complex as a charge control agent were mixed, and the resulting mixture was melt-kneaded using a twin-screw kneader which was set to a temperature of 120° C., whereby a kneaded material was obtained.

The thus obtained kneaded material was coarsely pulverized to a volume average particle diameter of 1.3 mm using a hammer mill manufactured by Nara Machinery Co., Ltd., whereby coarse particles were obtained.

Then, the obtained coarse particles were put into a bantam mill manufactured by Hosokawa Micron Corporation which was set to a rotational speed of 12000 rpm, whereby moderately pulverized particles were obtained. The volume average particle diameter of the moderately pulverized particles was measured using SALD-7000 (manufactured by Shimadzu Corporation) and found to be 48.9 μm.

40 Parts by weight of the moderately pulverized particles, 2 parts by weight of sodium dodecylbenzene sulfonate as a dispersing agent, 2 parts by weight of a sodium salt of a copolymer of acrylic acid and maleic acid, 2 parts by weight of triethylamine as a dispersing aid, and 55 parts by weight of ion exchanged water were preliminarily dispersed using ULTRA TURRAX T50 manufactured by IKA Japan K.K., whereby a preliminary dispersion liquid was obtained.

The thus obtained preliminary dispersion liquid was put into a Nanomizer (manufactured by Yoshida Kikai Co. Ltd., YSNM-2000AR additionally having a heating system). The temperature of the heating system was set to 200° C., and the dispersion liquid was processed at a processing pressure of 160 MPa in the Nanomizer. The processing was repeated three times. The volume average particle diameter of the colored particles obtained after cooling was measured using SALD-7000 (manufactured by Shimadzu Corporation) and found to be 0.56 μm. While maintaining the dispersion liquid at 40° C., 2 parts by weight of aluminum sulfate was added thereto, and the temperature of the mixture was raised to 63° C. to aggregate the colored fine particles to a desired volume average particle diameter, whereby an aggregated particle dispersion liquid was obtained. Thereafter, the temperature of the mixture was raised to 90° C. and the mixture was left as such for 3 hours, whereby a fused particle dispersion liquid was obtained.

Subsequently, the thus obtained fused particle dispersion liquid was subjected to washing by repeating filtration and washing with ion exchanged water until the electrical conductivity of the filtrate was lowered to 50 μS/cm. Then, drying was performed using a vacuum dryer until the water content was lowered to 1.0% by weight or less, whereby toner particles B were obtained.

The physical properties of the thus obtained toner particles were measured by the above-described methods, and it was found that the particle diameter was 5.0 the circularity was 0.960, the glass transition temperature was 44.1° C., and the storage stability at 47° C. was 20.0 g.

When substances present in the vicinity of the surfaces of the toner particles B were measured by HPLC, the ratio of a peak area at a retention time of 10 minutes or less to the total peak area was 73.6%.

The toner particles B were redispersed in the same manner as in Example 1, whereby a toner particle dispersion liquid having a solid content of 2% was obtained. While stirring the dispersion liquid, an aqueous solution of 0.1 wt % KOH was added dropwise thereto to adjust the pH thereof to 9.6. Then, the temperature of the dispersion liquid was raised to 50° C., and heating was performed for 1 hour. After being cooled naturally, the resulting dispersion liquid was filtered, and the residue was washed and dried, whereby the toner particles B subjected to the heating treatment were obtained. The thus obtained toner particles B subjected to the heating treatment had a particle diameter of 5.8 μm, a circularity of 0.942, and a storage stability at 47° C. of 1.8 g.

The toner particles B subjected to the heating treatment were dispersed in methanol, and components present in the vicinity of the surface were extracted at 50° C. for 3 hours, and the extracted components were subjected to HPLC measurement. As a result, the ratio of a peak area at a retention time of 10 minutes or less to the total peak area was 51.4%. In addition, the ratio of a peak area at a retention time of 10 minutes or less to the total peak area before the heating treatment was 73.6%. Further, the ratio of the peak area before and after the heating treatment was 69.9%.

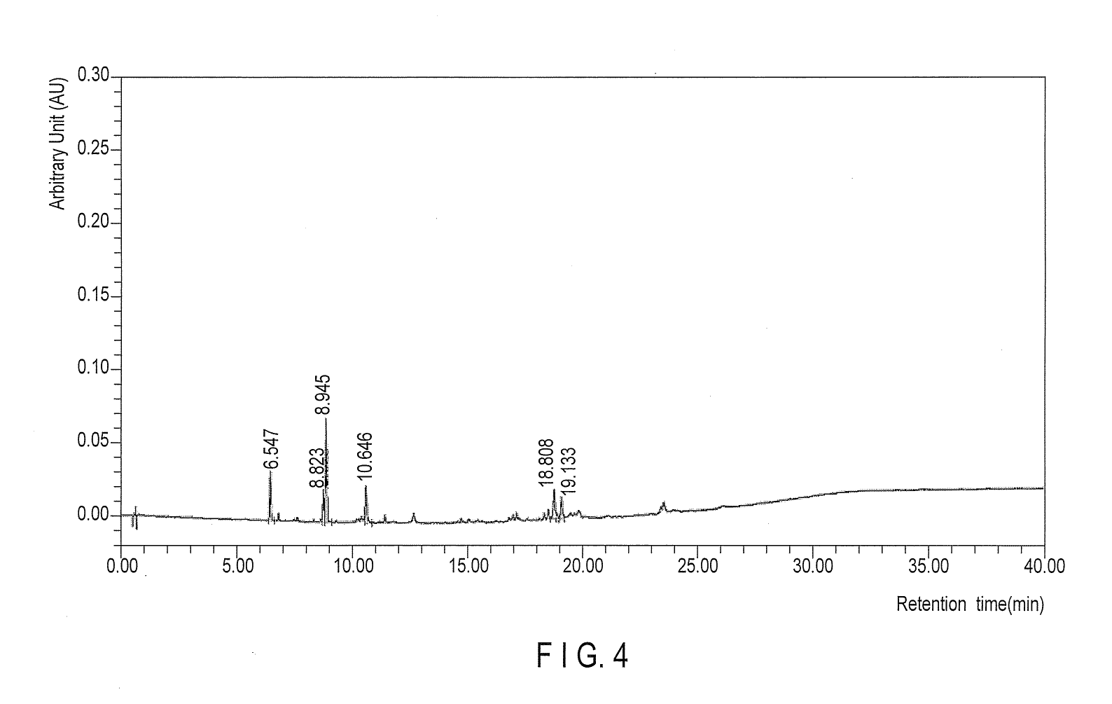

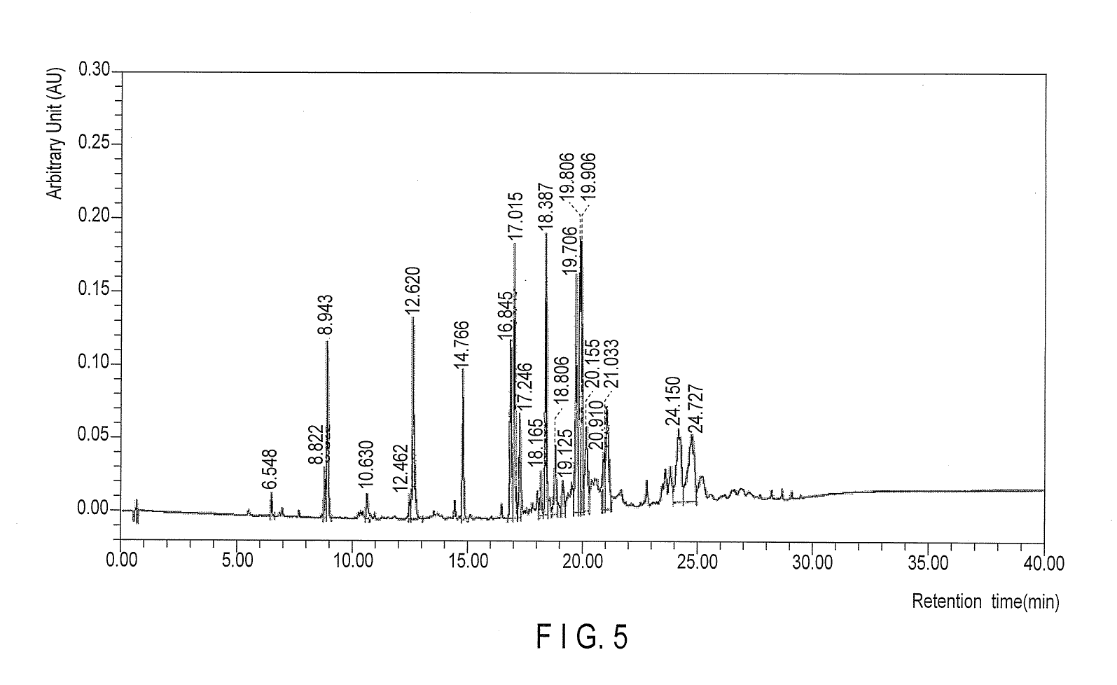

The graph showing the results of HPLC measurement of the toner particles B before the heating treatment is shown in FIG. 4 and after the heating treatment is shown in FIG. 5.

Further, the results of the peak area determined by the HPLC measurement of the toner particles B before and after the heat treatment are shown in the following Table 1. In addition, the results of the percentage of the area determined by the HPLC measurement are shown in the following Table 2. Further, the results of the respective measurements are shown in Table 3.

TABLE 1
Peak area of each sample

| | Toner particles A | Toner particles B | | Toner particles A | Toner particles B |
|---|---|---|---|---|---|
| Retention time | (before heating | (before heating | | (after heating | (after heating |
| (min) | treatment) | treatment) | Toner particles C | treatment) | treatment) |
| 0.99 | — | — | — | — | — |
| 6.55 | 86599 | 108371 | 60992 | 50163 | 70673 |
| 8.82 | 167254 | 75704 | 50047 | 120218 | 68253 |
| 8.94 | 589489 | 256104 | 265785 | 437104 | 229157 |
| 10.00 | 305207 | 102808 | 504812 | 85941 | — |
| 12.45 | 145715 | — | 178456 | 72433 | — |
| 12.60 | 1369986 | — | 1216398 | 727972 | — |
| 14.76 | 351852 | — | 319685 | 422832 | — |
| 16.84 | 496727 | — | 443020 | 566082 | — |
| 17.01 | 700227 | — | 733675 | 800347 | — |
| 17.24 | 291531 | — | 305253 | 338328 | — |
| 18.16 | 111312 | — | 182724 | 128374 | — |
| 18.38 | 726098 | — | 535242 | 811113 | — |
| 18.80 | 267992 | 112366 | 79479 | 284821 | 204310 |
| 19.12 | 154787 | 82190 | 150446 | 145377 | 143261 |
| 19.71 | 717050 | — | 482872 | 818868 | — |
| 19.87 | 763182 | — | 560191 | 803082 | — |
| 19.94 | 653120 | — | 417682 | 723491 | — |
| 20.15 | 459697 | — | 554352 | 489987 | — |
| 20.92 | 203141 | — | 447302 | 263634 | — |
| 21.04 | 495580 | — | 338785 | 597883 | — |
| 24.22 | 519858 | — | 398748 | 736709 | — |
| 24.76 | 616852 | — | 680137 | 869936 | — |
| Total area | 10193256 | 737543 | 8906083 | 10294695 | 715654 |

TABLE 2
Percentage of area of each sample

| | Toner particles A | Toner particles B | | Toner particles A | Toner particles B |
|---|---|---|---|---|---|
| Retention time | (before heating | (before heating | | (after heating | (after heating |
| (min) | treatment) | treatment) | Toner particles C | treatment) | treatment) |
| 0.99 | — | — | — | — | — |
| 6.55 | 0.8 | 14.7 | 0.7 | 0.5 | 9.9 |
| 8.82 | 1.6 | 10.3 | 0.6 | 1.2 | 9.5 |
| 8.94 | 5.8 | 34.7 | 3.0 | 4.2 | 32.0 |
| 10.00 | 3.0 | 13.9 | 5.7 | 0.8 | — |
| 12.45 | 1.4 | — | 2.0 | 0.7 | — |
| 12.60 | 13.4 | — | 13.7 | 7.1 | — |
| 14.76 | 3.5 | — | 3.6 | 4.1 | — |
| 16.84 | 4.9 | — | 5.0 | 5.5 | — |
| 17.01 | 6.9 | — | 8.2 | 7.8 | — |
| 17.24 | 2.9 | — | 3.4 | 3.3 | — |
| 18.16 | 1.1 | — | 2.1 | 1.2 | — |
| 18.38 | 7.1 | — | 6.0 | 7.9 | — |
| 18.80 | 2.6 | 15.2 | 0.9 | 2.8 | 28.5 |
| 19.12 | 1.5 | 11.1 | 1.7 | 1.4 | 20.0 |
| 19.71 | 7.0 | — | 5.4 | 8.0 | — |
| 19.87 | 7.5 | — | 6.3 | 7.8 | — |
| 19.94 | 6.4 | — | 4.7 | 7.0 | — |
| 20.15 | 4.5 | — | 6.2 | 4.8 | — |
| 20.92 | 2.0 | — | 5.0 | 2.6 | — |
| 21.04 | 4.9 | — | 3.8 | 5.8 | — |
| 24.22 | 5.1 | — | 4.5 | 7.2 | — |
| 24.76 | 6.1 | — | 7.6 | 8.5 | — |
| Percentage of | 100 | 100 | 100 | 100 | 100 |
| total area | | | | | |

TABLE 3

| | Example 1 | | | Comparative Example 1 | |
|---|---|---|---|---|---|
| | Toner particles A | Toner particles A | | Toner particles B | Toner particles B |
| | before heating | after heating | Example 2 | before heating | after heating |
| | treatment | treatment | Toner particles C | treatment | treatment |
| Particle diameter [μm] | 4.8 | 5.2 | 4.8 | 5.0 | 5.8 |
| Circularity | 0.963 | 0.966 | 0.950 | 0.960 | 0.942 |
| Storage stability at 47° C. [g] | 0.1 | 0.1 | 0.1 | 20.0 | 1.8 |
| Storage stability at 60° C. [g] | 20.0 | 0.1 | 0.1 | 20.0 | 20.0 |
| Ratio of peak area at | 11.3 | 6.7 | 9.9 | 73.6 | 51.4 |
| retention time of 10 min or | | | | | |
| less to total peak area [%] | | | | | |

| | | | |
|---|---|---|---|
| Ratio of peak area before and | 59.8 | — | 69.9 |
| after heating treatment [%] | | | |

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A developing agent comprising a binder resin and a coloring agent, wherein when the developing agent is subjected to methanol extraction under the following condition 1, and a filtrate of the resulting extract is subjected to HPLC measurement under the following condition 2, the ratio of a peak area at a retention time of 10 minutes or less to the total peak area is 15.0% or less:
Condition 1 for methanol extraction:
Methanol: 20 parts by weight;
Toner: 2 parts by weight;
Extraction temperature: 50° C.;
Extraction time: 3 hours; and
Filter paper: ADVANTEC GC90,
Condition 2 for HPLC measurement:
Column: Acquity HPLC BEH C8 1.7 μm 2.1×100 mm Column;
Column temperature: 40° C.;
Mobile phase A: acetonitrile;
Mobile phase B: aqueous solution of 0.1% acetic acid;
Gradient condition: A/B=20/80 to 100/0 to 100/0, 0 min to 30 min to 40 min;
Detector: PDA (measurement wavelength: 254 nm, wavelength resolution 1.2 nm); and
Injection amount: 2 μL.

2. The developing agent according to claim 1, wherein the developing agent is obtained by a method for producing a developing agent, comprising:
preparing a toner material dispersion liquid by mixing a particulate mixture containing a binder resin and a coloring agent with an aqueous medium;
preparing a dispersion liquid containing fine particles having a particle diameter smaller than that of the particulate mixture by subjecting the toner material dispersion liquid to mechanical shearing to finely pulverize the particulate mixture;
forming aggregated particles by aggregating the fine particles in the dispersion liquid containing the fine particles;
forming fused particles by fusing the aggregated particles through heating;
separating toner particles by filtering the fused particles;
preparing a toner particle dispersion liquid by mixing the toner particles with the aqueous medium; and
heating the toner particle dispersion liquid to a temperature higher than the glass transition temperature of the binder resin.

3. The developing agent according to claim 2, wherein the separating toner particles includes washing the fused particles before filtering the fused particles, and drying the fused particles after filtering the fused particles.

4. A method for evaluating a developing agent, wherein evaluation is performed by subjecting a developing agent containing a binder resin and a coloring agent to methanol extraction under the following condition 1, subjecting a filtrate of the resulting extract to HPLC measurement under the following condition 2, and determining as to whether or not the ratio of a peak area at a retention time of 10 minutes or less to the total peak area is 15.0% or less:
Condition 1 for methanol extraction:
Methanol: 20 parts by weight;
Toner: 2 parts by weight;
Extraction temperature: 50° C.;
Extraction time: 3 hours; and
Filter paper: ADVANTEC GC90,
Condition 2 for HPLC measurement:
Column: Acquity HPLC BEH C8 1.7 μm 2.1×100 mm Column;
Column temperature: 40° C.;
Mobile phase A: acetonitrile;
Mobile phase B: aqueous solution of 0.1% acetic acid;
Gradient condition: A/B=20/80 to 100/0 to 100/0, 0 min to 30 min to 40 min;
Detector: PDA (measurement wavelength: 254 nm, wavelength resolution 1.2 nm); and
Injection amount: 2 μL.

5. The method according to claim 4, wherein the developing agent is obtained by a method for producing a developing agent, comprising:
preparing a toner material dispersion liquid by mixing a particulate mixture containing a binder resin and a coloring agent with an aqueous medium;
preparing a dispersion liquid containing fine particles having a particle diameter smaller than that of the particulate mixture by subjecting the toner material dispersion liquid to mechanical shearing to finely pulverize the particulate mixture;
forming aggregated particles by aggregating the fine particles in the dispersion liquid containing the fine particles;
forming fused particles by fusing the aggregated particles through heating;
separating toner particles by filtering the fused particles;
preparing a toner particle dispersion liquid by mixing the toner particles with the aqueous medium; and
heating the toner particle dispersion liquid to a temperature higher than the glass transition temperature of the binder resin.

6. The method according to claim 5, wherein the separating toner particles includes washing the fused particles before filtering the fused particles, and drying the fused particles after filtering the fused particles.

7. A method for producing a developing agent, comprising:
preparing a toner material dispersion liquid by mixing a particulate mixture containing a binder resin and a coloring agent with an aqueous medium;
preparing a dispersion liquid containing fine particles having a particle diameter smaller than that of the particulate mixture by subjecting the toner material dispersion liquid to mechanical shearing to finely pulverize the particulate mixture;
forming aggregated particles by aggregating the fine particles in the dispersion liquid containing the fine particles;
forming fused particles by fusing the aggregated particles through heating;
separating toner particles by filtering the fused particles;
preparing a toner particle dispersion liquid by mixing the toner particles with the aqueous medium;
subjecting the toner particle dispersion liquid to a heating treatment at a temperature higher than the glass transition temperature of the binder resin; and
performing evaluation by separating the toner particles subjected to the heating treatment from the aqueous medium, subjecting the separated toner particles to methanol extraction under the following condition 1, subjecting a filtrate of the resulting extract to HPLC measurement under the following condition 2, and determining as to whether or not the ratio of a peak area at a retention time of 10 minutes or less to the total peak area is 15.0% or less:
Condition 1 for methanol extraction:
Methanol: 20 parts by weight;
Toner: 2 parts by weight;
Extraction temperature: 50° C.;
Extraction time: 3 hours; and
Filter paper: ADVANTEC GC90,
Condition 2 for HPLC measurement:
Column: Acquity HPLC BEH C8 1.7 μm 2.1×100 mm Column;
Column temperature: 40° C.;
Mobile phase A: acetonitrile;
Mobile phase B: aqueous solution of 0.1% acetic acid;
Gradient condition: A/B=20/80 to 100/0 to 100/0, 0 min to 30 min to 40 min;
Detector: PDA (measurement wavelength: 254 nm, wavelength resolution 1.2 nm); and
Injection amount: 2 μL.

8. The method according to claim 7, wherein the separating toner particles includes washing the fused particles before filtering the fused particles, and drying the fused particles after filtering the fused particles.
